(19) United States
(12) Patent Application Publication
(10) Pub. No.: US 2007/0270299 A1
(43) Pub. Date: Nov. 22, 2007

(54) Glass-ceramics and methods of making same

(75) Inventors: Anatoly Z. Rosenflanz, Maplewood, MN (US); Thomas J. Anderson, Cottage Grove, MN (US); Donna W. Bange, Eagan, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/521,842

(22) Filed: Sep. 15, 2006

Related U.S. Application Data
(60) Provisional application No. 60/747,471, filed on May 17, 2006.

(51) Int. Cl. C03C 10/02

(52) U.S. Cl. 501/10; 65/33.1

(57) ABSTRACT

A glass-ceramic and methods for making glass-ceramics that exhibit a combination of high hardness and high in-line transmission.

### CROSS REFERENCE TO RELATED APPLICATION

This application claims the benefit of U.S. Provisional Patent Application No. 60/747,471, filed May 17, 2006, the disclosure of which is incorporated by reference herein in its entirety.

### FIELD OF INVENTION

The present disclosure relates generally to glass-ceramics. More particularly, the present disclosure relates to glass-ceramic and methods for making glass-ceramics that exhibit a combination of high hardness and high in-line transmission.

### BACKGROUND

A large number of glass and glass-ceramic compositions are known. The majority of oxide glass systems utilize well-known glass-formers such as SiO₂, B₂O₃, P₂O₅, GeO₂, and TeO₂ to aid in the formation of the glass. WIPO Publication Number WO 2003/011776 and Rosenflanz et al., Bulk glasses and ultrahard nanoceramics based on alumina and rare-earth oxides, Nature 430, 761-64 (2004), report novel bulk glass compositions that can be formed by consolidating glass bodies (e.g., a plurality of glass beads) that exhibit T_{g} and Tₓ. In some instances, these glass compositions have been heat-treated to form glass-ceramics having a high-hardness. The in-line transmission values of these glass-ceramics, however, have been lower than 50 percent of their theoretical maximum. Accordingly, the in-line transmission of these glass-ceramics may compromise their utility in certain applications, including, for example, transparent protective covers (e.g., watch covers, electronic casings, light source protectors, etc.). There remains a need for a glass-ceramic that exhibit a combination of high hardness and high in-line transmission.

### SUMMARY

The present disclosure relates generally to glass-ceramics. More particularly, the present disclosure relates to glass-ceramic and methods for making glass-ceramics that exhibit a combination of high hardness and high in-line transmission.

One embodiment of the present disclosure is a method for determining an end-point for a heat-treatment protocol to optimize hardness and in-line transmission of the resulting glass-ceramic composition. Surprisingly, it was found that glass-ceramic precursors of the present disclosure can be heat-treated to a transition point (i.e., a Transmission Loss Point, as defined herein) that facilitates optimization of hardness and in-line transmission of the glass-ceramic. The Transmission Loss Point can be determined by generating a series of data and evaluated the data to determine the point at which any further progression in the heat-treatment protocol (e.g., increase in temperature and/or residence time) results in an irreversible and marked decline in in-line transmission.

Using the methods of the present disclosure, glass-ceramic articles can be made with a combination of high hardness (i.e., at least 11 GPa) or high Young's Modulus (i.e., at least 150 GPa) and high in-line transmission (i.e., at least 50% of theoretical maximum). The glass-ceramic articles of the present disclosure can be used in a variety of applications, including, for example, as a replacement for sapphire. The glass-ceramics of the present disclosure are generally more economical, and offer greater manufacturing and design flexibility than sapphire.

The resulting glass-ceramics may be employed as display covers, cell phone display covers, PDA display covers, portable electronic device display covers and the like. Alternatively, the resulting glass-ceramics may be employed as cases including cases for watches, timepieces, cell phones, PDA's, portable electronic devices and music devices and the like.

In one application, the glass ceramic article is employed as a protective cover for a timepiece. This timepiece may be a watch or clock. This protective cover may serve to protect the actual timepiece or may be a casing for the timepiece.

In this application:

“amorphous material” refers to material derived from a melt and/or a vapor phase that lacks any long range crystal structure as determined by X-ray diffraction and/or has an exothermic peak corresponding to the crystallization of the amorphous material as determined by DTA (differential thermal analysis);

“ceramic” includes glass, crystalline ceramic, and combinations thereof;

“complex metal oxide” refers to a metal oxide comprising two or more different metal elements and oxygen (e.g., CeAl₁₁O₁₈, Dy₃Al₅O₁₂, MgAl₂O₄, and Y₃Al₅O₁₂);

“differential thermal analysis” or “DTA” refers to a procedure that involves measuring the difference in temperature between a sample and a thermally inert reference, such as Al₂O₃, as the temperature is raised. A graph of the temperature difference as a function of the temperature of the inert reference provides information on exothermic and endothermic reactions taking place in the sample. An exemplary instrument for performing this procedure is available from Netzsch Instruments, Selb, Germany under the trade designation “NETZSCH STA 409 DTA/TGA”. A suitable amount, e.g., 400 mg, of a sample can be placed in a suitable inert holder (e.g. a 100 ml Al₂O₃ sample holder) and heated in static air at a suitable rate, e.g. 10° C./minute, from an initial temperature (e.g. room temperature, or about 25° C.) to a final temperature, such as 1200° C.;

“glass” refers to amorphous material exhibiting a glass transition temperature;

“glass-ceramic” refers to ceramic comprising crystals formed by heat-treating glass;

“glass-ceramic precursor” refers to the glass body that is subjected to heat-treatment to form a glass-ceramic;

“heat-treatment protocol” refers to all processing parameters (e.g., temperature, time, pressure, etc.) of the heat-treatment process;

“T_{g}” refers to the glass transition temperature as determined by DTA (differential thermal analysis);

“Tₓ” refers to the crystallization temperature as determined by DTA (differential thermal analysis);

“Transmission Loss Point” refers to the onset point for a given glass heat-treatment protocol at which further progression in the heat-treatment protocol (e.g., increase in temperature and/or residence time) causes an irreversible and marked decline in in-line transmission. The Transmission Loss Point for a composition is unique for a given heat-treatment protocol; and

“rare earth oxides” or “REO” refers to cerium oxide (e.g., CeO₂), dysprosium oxide (e.g., Dy₂O₃), erbium oxide (e.g., Er₂O₃), europium oxide (e.g., Eu₂O₃), gadolinium oxide (e.g., Gd₂O₃), holmium oxide (e.g., Ho₂O₃), lanthanum oxide (e.g., La₂O₃), lutetium oxide (e.g., Lu₂O₃), neodymium oxide (e.g., Nd₂O₃), praseodymium oxide (e.g., Pr₆O₁₁), samarium oxide (e.g., Sm₂O₃), terbium oxide (e.g., Tb₂O₃), thorium oxide (e.g., Th₄O₇), thulium oxide (e.g., Tm₂O₃), and ytterbium oxide (e.g., Yb₂O₃), and combinations thereof.

Further, it is understood herein that unless it is stated that a metal oxide (e.g., Al₂O₃, complex Al₂O₃.metal oxide, etc.) is crystalline, for example, in a glass-ceramic, it may be glassy, crystalline, or portions glassy and portions crystalline state. For example, if a glass-ceramic comprises Al₂O₃ and ZrO₂, the Al₂O₃ and ZrO₂ may each be in a glassy state, crystalline state, or portions in a glassy state and portions in a crystalline state, or even as a reaction product with another metal oxide(s) (e.g., unless it is stated that, for example, Al₂O₃ is present as crystalline Al₂O₃ or a specific crystalline phase of Al₂O₃ (e.g., alpha Al₂O₃), it may be present as crystalline Al₂O₃ and/or as part of one or more crystalline complex Al₂O₃.metal oxides).

The above summary of making glass-ceramics according to the present disclosure is not intended to describe each disclosed embodiment of every implementation of making glass-ceramics according to the present disclosure. The detailed description that follows more particularly exemplify illustrative embodiments. The recitation of numerical ranges by endpoints includes all numbers subsumed with that range (e.g., 1 to 5 includes 1, 1.5, 2, 2.75, 3, 4, 4.80, and 5).

### DETAILED DESCRIPTION

WIPO Publication Number WO 2003/011776 and Rosenflanz et al., Bulk glasses and ultrahard nanoceramics based on alumina and rare-earth oxides, Nature 430, 761-64 (2004), report novel glass compositions that can be used to form glass-ceramic precursors useful in making glass-ceramics according to the present disclosure, and are incorporated herein by reference. Glass-ceramic precursors useful in making glass-ceramics according to the present disclosure can also be obtained by other techniques, such as direct melt casting, melt atomization, containerless levitation, laser spin melting, and other methods known to those skilled in the art (see, e.g., Rapid Solidification of Ceramics, Brockway et al., Metals And Ceramics Information Center, A Department of Defense Information Analysis Center, Columbus, Ohio, January, 1984).

The glass-ceramic precursor generally comprises a mixture of at least two metal oxides (or complex metal oxides). Metal oxides that may be used to form the glass-ceramic precursor include, for example, Al₂O₃; TiO₂; rare earth oxides (REO's) such as CeO₂, Dy₂O₃, Er₂O₃, Eu₂O₃, Gd₂O₃, Ho₂O₃, La₂O₃, Lu₂O₃, Nd₂O₃, Pr₆O₁₁, Sm₂O₃, Tb₂O₃, Th₄O₇, Tm₂O₃, and Yb₂O₃; ZrO2, HfO₂, Ta₂O₅, Nb₂O₅, Bi₂O₃, WO₃, V₂O₅, Ga₂O₃, and alkaline earth metal oxides such as CaO and BaO. Examples of useful glass for making glass-ceramics according to the present disclosure include those comprising REO—TiO₂, REO—ZrO₂—TiO₂, REO—Al₂O₃, REO—Al₂O₃—ZrO₂, and REO—Al₂O₃—ZrO₂—SiO₂ glasses. Useful glass formulations include those at or near a eutectic composition.

In addition to these compositions and compositions disclosed in WIPO Publication Numbers WO 2003/011781, WO 2003/011776, WO 2005/061401, U.S. Patent Application having Ser. No. 11/273,513, filed Nov. 14, 2005 (Attorney Docket No. 61351US002), and Rosenflanz et al., Bulk glasses and ultrahard nanoceramics based on alumina and rare-earth oxides, Nature 430, 761-64 (2004), which are incorporated herein by reference, other compositions, including eutectic compositions, will be apparent to those skilled in the art after reviewing the present disclosure.

In some embodiments, the first and second metal oxides are each selected from the group consisting of Al₂O₃, Bi₂O₃, CaO, CoO, Cr₂O₃, CuO, Fe₂O₃, Ga₂O₃, HfO₂, MgO, MnO, Nb₂O₅, NiO, REO, Sc₂O₃, Ta₂O₅, TiO₂, V₂O₅, Y₂O₃, ZnO, ZrO₂, and complex metal oxides thereof.

In some embodiments, a first metal oxide is selected from the group consisting of Al₂O₃, CaO, CoO, Cr₂O₃, CuO, Fe₂O₃, HfO₂, MgO, MnO, Nb₂O₅, NiO, REO, Sc₂O₃, Ta₂O₅, TiO₂, V₂O₅, Y₂O₃, ZnO, ZrO₂, and complex metal oxides thereof, and a second metal oxide is selected from the group consisting of Al₂O₃, Bi₂O₃, CaO, CoO, Cr₂O₃, CuO, Fe₂O₃, Ga₂O₃, HfO₂, MgO, MnO, Nb₂O₅, NiO, REO, Sc₂O₃, Ta₂O₅, TiO₂, V₂O₅, Y₂O₃, ZnO, ZrO₂, and complex metal oxides thereof. In some embodiments, the first metal oxide is selected from the group consisting of Al₂O₃, REO, TiO₂, Y₂O₃, ZrO₂, and complex metal oxides thereof.

In some instances, it may be preferred to incorporate limited amounts of oxides selected from the group consisting of: B₂O₃, GeO₂, P₂O₅, SiO₂, TeO₂, and combinations thereof. These metal oxides, when used, are typically added in the range of 0 to 20 (in some embodiments 0 to 15, 0 to 10, or even 0 to 5) percent of the glass-ceramic precursor depending, for example, upon the desired property.

In some embodiments, the glass-ceramic precursor comprises at least 20 (in some embodiments, preferably at least 25, 30, 35, 40, 45, 50, 55, 60, 65, 70 or even at least 75) percent by weight Al₂O₃, based on the total weight of the glass-ceramic precursor, and a metal oxide other than Al₂O₃ (e.g., Bi₂O₃, CaO, CoO, Cr₂O₃, CuO, Fe₂O₃, Ga₂O₃, HfO₂, MgO, MnO, Nb₂O₅, NiO, REO, Sc₂O₃, Ta₂O₅, TiO₂, V₂O₅, Y₂O₃, ZnO, ZrO₂, and complex metal oxides thereof).

In some embodiments, the glass-ceramic precursor is formed by coalescing a plurality of glass bodies (e.g., beads) comprising a first metal oxide and a second metal oxide, wherein the difference between T_{g} and Tₓ is at least 5 degrees Celsius, and wherein the glass bodies contain not more than 20 (in some embodiments 15, 10, 5, 3, 2, or even 1) percent by weight SiO₂, not more than 20 (in some embodiments 15, 10, 5, 3, 2, or even 1) percent by weight B₂O₃, and not more than 40 (in some embodiments 30, 20, 10, 5, 3, 2, or even 1) percent by weight P₂O₅, based on the total weight of the glass bodies. The coalescing step can be conducted by applying heat and/or pressure to the plurality of glass bodies. WIPO Publication Number WO 2003/011776, incorporated herein by reference, discloses methods for coalescing a plurality of glass bodies. The coalescing process can be used to shape the glass-ceramic precursor to a desired geometry. The glass-ceramic precursor can also be shaped using methods reported in copending application having U.S. Ser. No. 60/797,847 (Attorney Docket No. 62097US002), entitled “Method of Reshaping a Glass Body”, filed May 3, 2006, the disclosure of which is incorporated herein by reference.

Various forming methods can be used to prepare shaped articles comprising glass-ceramics precursor of the present disclosure. These methods generally fall into one of the two categories: 1) permanent mold process or 2) expendable mold process. In a permanent mold process, mold tooling (e.g., ceramics, graphite, cermets) are repeatedly used in multiple cycles. In an expendable mold process, the mold is used once. Examples of expendable mold processes include investment casting of metals into molds made from refractory materials. One further example of the expendable mold process used for making shaped ceramic bodies is described in U.S. Pat. No. 6,465,106, incorporated herein by reference. This process, (sometimes referred to as a lost wax technique) involves forming refractory investment mold, inserting the material into the mold, heating and applying pressure to the material such that it fills the mold cavity to form the desired shape. This process can be combined with coalescence of the glass-ceramic precursor particles or conducted using an already coalesced body.

Permanent mold processes are typically used for mass production of parts of similar overall shape and geometry, while the expendable mold process is typically used for preparation of highly customized parts. In one embodiment of the present disclosure, highly customized display covers, including watch covers, cell phone display covers, PDA display covers, portable electronic device display covers and the like; cases including cases for watches, timepieces, cell phones, PDA's, portable electronic devices and music devices and the like are prepared using the following steps:

1) Preparation of a wax copy of a desired article (timepiece, etc.),

2) Preparation of a refractory investment mold with a mold cavity replica of the article,

3) Inserting precursor material to glass-ceramics of the present invention into the mold,

4) Heating and applying pressure to fill the mold cavity, and

5) Removing the shaped article from the refractory mold.

Customized articles prepared according to the method above are expected to be especially beneficial for the luxury segment of the markets for protective covers and cases.

In some embodiments, a combination of glass bodies that vary in composition and/or size can be coalesced to form the glass-ceramic precursor. The chosen compositions may be varied to create a glass-ceramic precursor with discontinuous properties. The discontinuous properties can create a glass-ceramic with varying appearance attributes. For example, the glass-ceramic can have shading effects, graded index of refraction, varying colors, and the like. Additions of transparent materials (i.e glass, crystalline bodies) based on Al₂O₃, TiO₂, ZrO₂, Nb₂O₅ and Ta₂O₅ to a portion of the glass bodies based on Al₂O₃, for example, may result in graded index of refraction and other light interference effects. Additions of optically active rare earth ions such as Nd₂O₃ Er₂O₃, Eu₂O₃, may affect the color. Likewise, the combination of different glass bodies may affect various thermo-mechanical, diffusional and physical properties, including, for example, coefficient of thermal expansion, thermal conductivity, electronic and ionic conductivity, hardness, fracture toughness, strength and density.

The glass bodies that vary in composition may be uniformly mixed prior to coalescing or the glass bodies that vary in composition may be purposely segregated, for example, to form distinct layers or three-dimensional formations within the resulting article. For instance, depending upon the composition of the glass bodies and/or process conditions, after coalescing the resulting article may comprise distinct layers. These layers can be alternated to achieve a desired result. Conversely, after coalescing there may be migration of one layer into the other layer. The composition of the glass bodies and/or processing can be optimized to change any migration effect.

In one example, the glass body compositions can be chosen and oriented such that the outer portion of the glass-ceramic precursor may contain a harder composition and the inner portion may have higher strength. The compositions can also be chosen such that different portions of the glass-ceramic precursor exhibit different coefficients of thermal expansions, different thermal conductivity and diffusivity (e.g. gas diffusivity). Similarly the outer portion may contain a glass composition of a different color, shade or other optical effect from the inner portion.

The glass bodies to be coalesced can also be mixed with non-glass materials to create a composite glass-ceramic precursor. Examples of such non-glass materials include: metals (e.g., aluminum, carbon steel, etc.) crystalline metal oxides (alumina, silica, zirconia, rare earth oxides, yttria, magnesia, calcia, etc.), metal carbides, metal nitrides, metal borides, diamond and the like. The non-glass material should not degrade upon the temperatures and pressures of coalescing and heat-treatment. In certain embodiments, non-glass material can be selectively removed (for example by etching, etc.) from a coalesced glass-ceramic precursor body. The composition of the composite glass-ceramic precursors may adversely affect the in-line transmission and/or hardness of the resulting glass-ceramic.

In some articles, a second material selected from the group consisting of glass, a second glass-ceramic, crystalline ceramic, metal, and plastic is combined with the glass-ceramic of the present disclosure to form the article. In some embodiments, the second material has as at least one physical property selected from the group consisting of hardness, color, density, and strength that is different from said physical property of the glass-ceramic of the present disclosure.

In general, glasses that can be used to form glass-ceramic precursors for making glass-ceramics according to the present disclosure can be made by heating the appropriate metal oxide sources to form a melt, desirably a homogenous melt, and then cooling the melt to provide glass. Some embodiments of glass materials can be made, for example, by melting the metal oxide sources in any suitable furnace (e.g., an inductive heated furnace, a gas-fired furnace, or an electrical furnace), or, for example, in a flame or plasma. The resulting melt is cooled by discharging the melt into any of a number of types of cooling media such as high velocity air jets, liquids, graphite or metal plates (including chilled plates), metal rolls (including chilled metal rolls), metal balls (including chilled metal balls), and the like.

In one method, glasses that can be used to form glass-ceramic precursors for making glass-ceramics according to the present disclosure can be made utilizing flame fusion as disclosed, for example, in U.S. Pat. No. 6,254,981, incorporated by reference. Briefly, the metal oxide source materials are formed into particles sometimes referred to as “feed particles”. Feed particles are typically formed by grinding, agglomerating (e.g., spray-drying), melting, or sintering the metal oxide sources. The size of the feed particles fed into the flame generally determines the size of the resulting amorphous particle material. The feed particles are fed directly into a burner such as a methane-air burner, an acetylene-oxygen burner, a hydrogen-oxygen burner, and like. The materials are subsequently quenched in, for example, water, cooling oil, air, or the like.

Other techniques for forming melts, cooling/quenching melts, and/or otherwise forming glass include vapor phase quenching, plasma spraying, melt-extraction, gas or centrifugal atomization, thermal (including flame or laser or plasma-assisted) pyrolysis of suitable precursors, physical vapor synthesis (PVS) of metal precursors, and mechanochemical processing.

The cooling rate is believed to affect the properties of the quenched amorphous material. For instance, glass transition temperature, density and other properties of glass typically change with cooling rates. Rapid cooling may also be conducted under controlled atmospheres, such as a reducing, neutral, or oxidizing environment to maintain and/or influence the desired oxidation states, etc., during cooling. The atmosphere can also influence glass formation by influencing crystallization kinetics from undercooled liquid.

Heat-treatment of the glass-ceramic precursor can be carried out in any of a variety of ways, including those known in the art for heat-treating glass to provide glass-ceramics. For example, heat-treatment can be conducted in batches, for example, using resistive, inductively or gas heated furnaces. Alternatively, for example, heat-treatment can be conducted continuously, for example, using rotary kilns. In the case of a rotary kiln, the material is fed directly into a kiln operating at the elevated temperature. The time at the elevated temperature may range from a few seconds (in some embodiments even less than 5 seconds) to a few minutes to several hours. The temperature may range anywhere from 800° C. to 1600° C., typically between 900° C. to 1400° C. It is also within the scope of the present disclosure to perform some of the heat-treatment in batches (e.g., for the nucleation step) and another continuously (e.g., for the crystal growth step and to achieve the desired density). For the nucleation step, the temperature typically ranges between about 900° C. to about 1100° C., in some embodiments, preferably in a range from about 925° C. to about 1050° C. This heat treatment may occur, for example, by feeding the material directly into a furnace at the elevated temperature. Alternatively, for example, the material may be fed into a furnace at a much lower temperature (e.g., room temperature) and then heated to desired temperature at a predetermined heating rate. The heat-treatment can be conducted in an atmosphere other than air. In some cases it might be even desirable to heat-treat in a reducing atmosphere(s). Also, for, example, it may be desirable to heat-treat under gas pressure as in, for example, hot-isostatic press, or in gas pressure furnace.

In some embodiments, the target heat-treatment protocol for making a glass-ceramic article is determined by subjecting a plurality of test glass bodies to various extents of an experimental heat-treatment protocol. The term “target heat-treatment protocol” refers to the actual heat-treatment protocol that is used to heat-treat a glass-ceramic precursor to form a desired glass-ceramic article. The term “experimental heat-treatment protocol” refers to a heat-treatment protocol that is used to develop the target heat-treatment protocol by subjecting a plurality of test glass bodies to various extents of the experimental heat-treatment protocol in order to identify the Transmission Loss Point. The target heat-treatment protocol corresponds with the experimental heat-treatment protocol up to the end point of the target heat-treatment protocol, at which point the experimental heat-treatment protocol typically continues to progress (i.e., subjects the sample to further heat-treatment).

The heat-treatment protocol used to heat-treat glass-ceramic precursors in accordance with the present disclosure can be any protocol developed by those skilled in the art. For example, the heat-treatment protocol may include a temperature that increases at a constant rate (per unit time) while other variables are held constant. In other embodiments, the heat-treatment protocol may include a constant temperature and the extent of the heat-treatment is determined principally by the samples residence time. In yet further embodiments, the heat-treatment protocol includes temperature changes in steps. In yet further embodiments, the heat-treatment protocol has a constant residence time, a constant starting temperature, and the rate of temperature increases varies. In even further embodiments, multiple variables in the heat-treatment process change during the progression of the heat-treatment protocol.

After submitting the test glass bodies to various extents of the experimental heat-treatment protocol, the heat-treated test bodies can be evaluated for in-line transmission and optionally, hardness. The in-line (and optionally, hardness) data is then evaluated to determine the target heat-treatment-protocol to be applied to the glass-ceramic precursor to make the desired glass-ceramic article.

As hardness generally increases as the heat-treatment protocol proceeds, it may not be necessary to measure hardness to evaluate the resulting data to determine a target heat-treatment protocol.

In certain embodiments, the target heat-treatment protocol may comprise at least two stages. The first stage comprising heating to a temperature near the first crystallization temperature (±50 degrees) of the glass and holding the temperature for at least 1 minute, 5 minutes, 20 minutes or even 1 hour to at least crystallize a portion of the glass. The second stage comprises heating at essentially any rate and encompassing temperatures higher than the first stage holding temperature. In some embodiments, the glass-ceramic can be cooled from the holding temperature of the first stage to about room temperature and then reheated in a second stage. In some embodiments, conducting heat-treatment in accordance with a two stage protocol has been found to reduce cracking and warpage of the article. In certain embodiments this target protocol is also beneficial for minimizing total heat-treatment time, thus improving manufacturability.

In-line transmission of a sample can be determined using a conventional spectrophotometer such as Perkin Elmer Lambda 900 Spectrophotometer. Generally, transmission of optically homogeneous materials in the absence of absorption and scattering is limited only by the material-specific reflection R=((n−1)/(n+1))² at the front and back side and is dependent on refractive index, n only. The theoretical maximum value of transmission Tₜₕ is (1−R)². In the context of the present disclosure and appended claims, the in-line transmission value of a material is determined by measuring a 1.2 millimeter thick sample at a light wavelength between 600 and 650 nm.

The test glass bodies preferably have the same chemical and physical properties as the glass-ceramic precursor used to form the desired glass-ceramic article. In other embodiments, the chemical and physical properties of the test glass bodies are substantially the same as the chemical and physical properties of the glass-ceramic precursor used to form the desired glass-ceramic article. In yet further embodiments, the dimensions of the test glass bodies vary from the dimensions of the glass-ceramic precursor used to form the desired glass-ceramic article. Variations between the physical and/or chemical properties of the test glass bodies and the glass-ceramic precursor used to form the desired glass-ceramic article can be accounted for using information gathered from comparative experiments, as well as information and technical assessments known by those skilled in the art.

The in-line transmission (and optionally, hardness) data can be evaluated in a variety of ways depending on the desired properties of the glass-ceramic article. In some embodiments, a minimum in-line transmission value of the glass-ceramic article is required and it is desired to obtain a maximum hardness. In this scenario, the data can be evaluated by determining the heat-treatment protocol that provides maximum hardness while maintaining the minimum in-line transmission.

In other embodiments, it is desired to substantially optimize the in-line transmission and hardness of the glass-ceramic. In the context of the present disclosure, the in-line transmission and hardness are considered substantially optimized when any further progression in the heat-treatment protocol (e.g., increase in temperature and/or residence time) results in an irreversible and marked decline in in-line transmission.

In some embodiments, the in-line transmission (and optionally, hardness) data of the test bodies is evaluated to determine the Transmission Loss Point of the heat-treatment protocol. The heat-treatment protocol can then be followed until its Transmission Loss Point to make the desired glass-ceramic article. In some embodiments it may be desirable to exceed the Transmission Loss Point to form yet harder materials with lower in-line transmission. In this case, the target heat-treatment protocol proceeds beyond the Transmission Loss Point to achieve a desired combination of hardness and in-line transmission.

In some embodiments, the desired glass-ceramic article has an in-line transmission within 30 (in some embodiments 25, 20, 15, 10, or even within 5) percent of the in-line transmission of the glass-ceramic article at the Transmission Loss Point. In other embodiments, the desired glass-ceramic article is subject to a heat-treatment protocol that includes heating at a temperature that is within 50 (in some embodiments 40, 30, 20, or even within 10) degrees Celsius of the temperature of the Transmission Loss Point of the selected heat-treatment protocol.

In some embodiments, the glass-ceramic article made according to methods of the present disclosure has an in-line transmission that is at least 50 (in some embodiments 55, 60, 65, or even at least 70) percent of theoretical maximum. In some embodiments, the glass-ceramic article made according to methods of the present disclosure has a hardness of at least 11 (in some embodiments at least 12, 13, 14, 15, 16, 17, or even at least 18) GPa. In some embodiments, the glass-ceramic article made according to methods of the present disclosure has Young's modulus of at least 140 (in some embodiments at least 150, 175, 200, or even at least 250) GPa.

The hardness generally relates to the abrasion resistance of the resulting glass-ceramic and thus the ability of the glass-ceramic to withstand scratches. This ability to withstand scratches may be important for certain applications, including, for example, display covers, display covers for cell phones, watches, portable electronic devices, etc. In every day use, these display covers are typically exposed to a number of abrasive-like materials including sand, hard dust particles (garnet, aluminum oxide, silicon carbide, and the like) road debris and the like. This abrasion resistance may be especially important for electronic devices where a stylus or person's fingers are interacting with a touch screen.

Young's modulus relates to a stiffness of an article and is generally important in applications where lower degree of flexing due to either applied loads or centrifugal forces during rotation at high rpm are desired. In some embodiments of the present disclosure, glass-ceramics are provided with higher Young's modulus for use in protective windows for cell phones and glass memory disks.

The glass-ceramic articles made according to methods of the present disclosure can be made in a variety of sizes and shapes, depending on the desired application. In some embodiments, the glass-ceramic article has x, y, and z dimensions, each perpendicular to each other, and each of the x and y dimensions is at least 5 (in some embodiments 10, 25, 50, or even at least 100) millimeters. In some embodiments, the z dimension is at least 0.5 (in some embodiments 1, 2, 3, 5, 10, 25, 50, or even at least 100) millimeters.

The glass ceramic articles of the present disclosure can be used in a variety of applications, including, for example, as a replacement for sapphire. Exemplary articles that can be made using the glass ceramic and methods of the present disclosure include, for example, protective covers, watch covers (i.e., “crystals”), protective covers or lenses for electronic devices (e.g., Personal Digital Assistant (PDA's), portable music, video, and text devices, telephones, cameras, computers, etc.), video and computer screens, laser applications, metal halide and sodium vapor envelopes, window sensors, lighting elements, bearings, molds, mechanical parts, nozzles, valves, thread guides, lens, IR windows, tubes, rods, scanner windows, prisms, measuring instruments, and wave guides.

The resulting glass-ceramics may be employed as display covers, including watch covers, cell phone display covers, PDA display covers, digital cameras, video recorders, portable electronic device display covers and the like. The portable electronic devices also include portable digital audio players, CD players, portable games, radios, cameras, video recorders, audio recorders and the like. Cell phones may include clamshell, flip, slider or slide phones.

Alternatively, the resulting glass-ceramics may be employed as cases or housings including cases for watches, timepieces, cell phones, PDA's, portable electronic devices and the like.

A watch typically comprises a case that houses the movement and display means. A watch cover is typically positioned over the display to protect the display.

One embodiment of the present disclosure pertains to a watch cover. In another embodiment, the glass-ceramics of the present disclosure may be used to form a case or housing which serves to protect and/or house the mechanical and/or electronic components that form the timepiece. It is generally preferred that the watch cover have an in-line transmission of at least 50 percent of theoretical maximum and a hardness of at least 11 GPa. This hardness translates into improved abrasion resistance and resistance to scratches.

In another embodiment, the glass-ceramics of the present disclosure may be used to form a display cover of a device which protects the digital or analog device that conveys information to a person. In another aspect, the glass-ceramic is a case or housing which serves to protect and/or house the mechanical and/or electronic components that form the article. It is generally preferred that the display cover have an in-line transmission of at least 50 percent of theoretical maximum and a hardness of at least 11 GPa. This hardness translates into improved abrasion resistance and resistance to scratches.

The cover and case may be made of the same materials. Thus the watch cover and case appear to be an integrated timepiece. Similarly the display cover and the housing of a portable device appear to be an integrated article. The cover and case can be independently molded, such that when the two pieces are bonded together to appear as an integrated unit. (?)

There may be a gasket material in between the cover and case. In other embodiments, the cover and case can be integrally molded, such that cover and case are a single piece.

The timepiece may be a watch (including wrist watch and pocket watches), stopwatch or a clock (including alarm clocks, grandfather clocks, automotive clocks, table clocks, mantle clocks and the like). The timepiece may run off of electricity or be battery supplied.

The watch cover or case may have any desired shape or size. The shape may be any geometric shape including, for example, round, oval, triangular, square, rectangular, pentagon, hexagon, octagon half moon shape, quarter moon shape, star shape, diamond shape and the like. The timepiece cover may be flat, concave, convex or any combination thereof. The watch cover may have a dome structure. The outer surface of the cover or case may contain undulations. The size of the watch cover may range anywhere from 1 mm to greater than 500 mm in length and/or width. Typically for circular watch covers, the diameter ranges from 10 mm to 100 mm, usually 10 mm to 50 mm. For circular watch cases, the diameter typically ranges from 10 to 100 mm.

In some embodiments, the watch cover or case is coalesced or molded to the desired shape and size. In other embodiments, the watch cover or case can be machined (e.g., cut or abraded) to the desired shape and size. In some instances, it is preferred to mold indicia into the glass ceramic. For example, a company's brand or logo may be molded into a protective cover. The brand or logo may be raised or elevated above a plane for further emphasis. In some embodiments, raised portions over the numbers in an analog timepiece can be molded. Similarly numbers may be molded into the display cover. The glass may be molded such that the outer surface is relatively smooth. In other embodiments, the glass may be molded such that the outer surface has undulations, a texture, or a pre-determined pattern.

The watch cover or case may be tinted by applying an external coating over the outer surface of the cover or case. Alternatively, the tinting may be achieved by molding a specific metal oxide into the composition selected. The tint may be uniform throughout the cover or case or may be in only certain regions of the cover or case. The tinting between the watch cover and case may be the same or may be different. The tinting may be designed and configured to create different visual effects depending upon lighting. For example, natural sunlight may result in a different visual effect than interior lighting.

The watch cover or case may have a certain luster associated with it. This luster may be achieved by post processing, such as, for example, a coating may be applied to the external surface of the watch cover. In other embodiments, the glass-ceramic is formulated to achieve the luster in the molding process. In yet further embodiments, the luster may be achieved through a polishing process to create a desired surface finish.

The surface of the watch cover or case may contain a coating, such as, for example, a decorative coating or a protective coating. In some embodiments the coating is transparent. In other embodiments the coating is tinted. The coating may be a very hard coating, for example, a diamond-like coating, diamond film or boron nitride film. The coating over the watch cover or case may be a ceramic coating, polymeric coating, metallic coating or the like. The coating may be anti-reflective or anti-glare coating. The coating may be uniform or the coating may have a texture or pattern associated with it. The coating thickness typically ranges from 1 to 50 micrometers, more typically 1 to 25 micrometers.

In one aspect, the watch cover is made from the glass ceramic of the invention and the watch case is fabricated from a different material, such as, for example, metal (aluminum, stainless steel, titanium, silver, gold, platinum, and the like), plated metal (gold plated metal, silver plated metal, platinum plated metal), silicate glass, polymeric materials and the like. Depending upon the material, the case may be forged, diecast, molded or machined body.

It is also within the scope of the present disclosure to have precious jewels or gemstones present in the watch cover. For example, a gemstone may be bonded or embedded into the center of the watch cover. The gemstones may be bonded or embedded in the watch cover to represent the numbers on the watch facing.

### EXAMPLE

A porcelain jar was charged with 1000 g of DI water, pH of which was adjusted to 4 using HNO₃. Then the following oxide powders were added: 385 g Al₂O₃, 330 g La₂O₃, 100 g Gd₂O₃, and 185 g ZrO₂. The La₂O₃ powder was calcined at 700 C for 6 hrs prior to batch mixing. About 2000 g of alumina milling media was added to the jar and the contents were milled for 72 hrs at 120 rpm. After milling, the resulting slurry was transferred into a glass beaker and stirred with a magnetic stirrer. Immediately after transferring the slurry into the beaker, 40 ml of 0.5M solution of NH₄Cl was added which led to thickening of the slurry into a gel-like consistency. This gelatin-like substance was than transferred into glass trays and dried in forced convection air oven at 250 F. The obtained dried powder cake was further calcined at 1250 C for 2 h to completely remove any residual moisture.

After grinding with a mortar and pestle, the resulting screened particles were fed slowly (about 0.5 gram/minute) through a funnel, under a argon gas atmosphere 5 standard liter per minute (SLPM), into a hydrogen/oxygen torch flame which melted the particles and carried them directly into a 19-liter (5-gallon) rectangular container (41 centimeters (cm) by 53 cm by 18 cm height) of continuously circulating, turbulent water (20° C.) to rapidly quench the molten droplets. The torch was a Bethlehem bench burner PM2D Model B obtained from Bethlehem Apparatus Co., Hellertown, Pa. The torch had a central feed port (0.475 cm ( 3/16 inch) inner diameter) through which the feed particles were introduced into the flame. Hydrogen and oxygen flow rates for the torch were as follows. The hydrogen flow rate was 42 standard liters per minute (SLPM) and the oxygen flow rate was 18 SLPM. The angle at which the flame hit the water was approximately 90, and the flame length, burner to water surface, was approximately 38 centimeters (cm).

The resulting molten and quenched particles were collected in a pan and dried at 110 C. The particles were spherical in shape and ranged in size from a few tens of micron to up to 250 μm. From the fraction of beads measuring between 125 microns to 63 microns, greater than 95% were clear when viewed by an optical microscope.

5 g of beads sized between 90 microns and 125 microns was placed in a graphite die (10 mm in diameter) and hot-pressed at 915 C into a glass cylinder using 30 MPa of applied pressure. The glass cylinder was then sectioned into 1.2 mm thick disks that were polished to an optically-smooth surface.

In-line transmission data were generated using a conventional spectrophotometer such as Perkin Elmer Lambda 900 Spectrophotometer, and was found to be about 55% for light of a wavelength between 600 and 650 nm. For the refractive index of the material of this example (n=1.84), the Tₜₕ is 83.9%. Therefore, in-line transmission of the glass material of this example was about 66% of the theoretical maximum value.

The hardness measurements were made using a conventional microhardness tester (obtained under the trade designation “MITUTOYO MVK-VL” from Mitutoyo Corporation, Tokyo, Japan) fitted with a Vickers indenter using a 500-gram indent load. The microhardness measurements were made according to the guidelines stated in ASTM Test Method E384 Test Methods for Microhardness of Materials (1991), the disclosure of which is incorporated herein by reference. The hardness values were averaged over 20 measurements. The average hardness was found to be 9.23 GPa +/−0.12 GPa.

Glass disks prepared in the current example were further subjected to heat-treatment at various temperatures between 950° C. and 1250° C. in order to induce crystallization and increase hardness. Heat-treatment was conducted using a dilatometer available from Netzsch Instruments, Selb, Germany under the trade designation “NETZSCH STA 409 DTA/TGA”. Sample is placed in an Al₂O₃ sample holder and heated in static air at 10° C./minute, from an initial temperature (e.g. room temperature, or about 25° C.) to a final temperature, such as 950° C.

Optical transmission and hardness were measured at each annealing temperature. The results are shown in Table 1.

TABLE 1

| | Annealing | | | | | |
|---|---|---|---|---|---|---|
| | Temperature, degrees C. | | | | | |
| | 950 | 1050 | 1075 | 1100 | 1150 | 1250 |
| In-line Transmission, | 51.3 | 64.5 | 63.4 | 57.3 | 39.9 | 31 |
| % theoretical | | | | | | |
| Hardness, GPa | 10.2 | 12.5 | 12.8 | 13.0 | 14.0 | 15.8 |

Based on the results in Table 1, the temperature at the Transmission Loss Point for the chosen heat-treatment protocol is estimated to be around 1125° C. (the Transmission Loss Point could be determined more precisely by including additional annealing temperatures).

It is to be understood that even in the numerous characteristics and advantages of making glass-ceramics set forth in above description and examples, together with details of the structure and function of the disclosed glass-ceramic, the disclosure is illustrative only. Changes can be made to detail, especially in matters of glass-ceramic composition within the principles of the disclosure to the full extent indicated by the meaning of the terms in which the appended claims are expressed and the equivalents of those structures and methods.

What is claimed is:

1. A glass-ceramic comprising a first metal oxide selected from the group consisting of Al₂O₃, CaO, CoO, Cr₂O₃, CuO, Fe₂O₃, HfO₂, MgO, MnO, Nb₂O₅, NiO, REO, Sc₂O₃, Ta₂O₅, TiO₂, V₂O₅, Y₂O₃, ZnO, ZrO₂, and complex metal oxides thereof, and a second metal oxide selected from the group consisting of Al₂O₃, Bi₂O₃, CaO, CoO, Cr₂O₃, CuO, Fe₂O₃, Ga₂O₃, HfO₂, MgO, MnO, Nb₂O₅, NiO, REO, Sc₂O₃, Ta₂O₅, TiO₂, V₂O₅, Y₂O₃, ZnO, ZrO₂, and complex metal oxides thereof, wherein the first metal oxide and the second metal oxide are different from one another, and wherein the glass-ceramic has an in-line transmission of at least 50 percent of theoretical maximum and a hardness of at least 11 GPa.

2. The glass-ceramic of claim 1 wherein the glass-ceramic has x, y, and z dimensions each perpendicular to each other, and each of the x and y dimensions is at least 5 millimeters.

3. The glass-ceramic of claim 2 wherein the z dimension is at least 0.5 millimeter.

4. The glass-ceramic of claim 1 wherein the glass-ceramic comprises not more than 20 percent by weight collectively B₂O₃, GeO₂, P₂O₅, SiO₂, TeO₂, and combinations thereof, based on the total weight of the glass-ceramic.

5. The glass-ceramic of claim 1 having a hardness of at least 13 GPa.

6. The glass-ceramic of claim 1 wherein the first metal oxide is selected from the group consisting of Al₂O₃, REO, TiO₂, Y₂O₃, ZrO₂, and complex metal oxides thereof.

7. An article comprising the glass-ceramic of claim 1.

8. The article of claim 7 further comprising a second material selected from the group consisting of glass, a second glass-ceramic, crystalline ceramic, metal, and plastic, wherein said second material has as at least one physical property selected from the group consisting of hardness, color, density, and strength that is different from said physical property of said glass-ceramic.

9. The article of claim 7, wherein the article is selected from the group consisting of protective covers, cell phone display covers, portable electronic device display covers, watch covers, lighting elements, lenses, IR windows, tubes, rods, windows, prisms, and wave guides.

10. A watch comprising a watch cover, wherein said watch cover comprises a glass-ceramic comprising a first metal oxide selected from the group consisting of Al₂O₃, CaO, CoO, Cr₂O₃, CuO, Fe₂O₃, HfO₂, MgO, MnO, Nb₂O₅, NiO, REO, Sc₂O₃, Ta₂O₅, TiO₂, V₂O₅, Y₂O₃, ZnO, ZrO₂, and complex metal oxides thereof, and a second metal oxide selected from the group consisting of Al₂O₃, Bi₂O₃, CaO, CoO, Cr₂O₃, CuO, Fe₂O₃, Ga₂O₃, HfO₂, MgO, MnO, Nb₂O₅, NiO, REO, Sc₂O₃, Ta₂O₅, TiO₂, V₂O₅, Y₂O₃, ZnO, ZrO₂, and complex metal oxides thereof, wherein the first metal oxide and the second metal oxide are different from one another, and wherein the glass-ceramic has an in-line transmission of at least 50 percent of theoretical maximum and a hardness of at least 11 GPa.

11. A glass-ceramic comprising a first metal oxide selected from the group consisting of Al₂O₃, CaO, CoO, Cr₂O₃, CuO, Fe₂O₃, HfO₂, MgO, MnO, Nb₂O₅, NiO, REO, Sc₂O₃, Ta₂O₅, TiO₂, V₂O₅, Y₂O₃, ZnO, ZrO₂, and complex metal oxides thereof, and a second metal oxide selected from the group consisting of Al₂O₃, Bi₂O₃, CaO, CoO, Cr₂O₃, CuO, Fe₂O₃, Ga₂O₃, HfO₂, MgO, MnO, Nb₂O₅, NiO, REO, Sc₂O₃, Ta₂O₅, TiO₂, V₂O₅, Y₂O₃, ZnO, ZrO₂, and complex metal oxides thereof, wherein the first metal oxide and the second metal oxide are different from one another, and wherein the glass-ceramic has an in-line transmission of at least 50 percent of theoretical maximum and a Young's modulus of at least 150 GPa.

12. The glass-ceramic of claim 11 wherein the glass-ceramic has x, y, and z dimensions each perpendicular to each other, and each of the x and y dimensions is at least 5 millimeters.

13. The glass-ceramic of claim 11 wherein the z dimension is at least 0.5 millimeter.

14. The glass-ceramic of claim 11 wherein the glass-ceramic comprises not more than 20 percent by weight collectively B₂O₃, GeO₂, P₂O₅, SiO₂, TeO₂, and combinations thereof, based on the total weight of the glass-ceramic.

15. The glass-ceramic of claim 11 wherein the first metal oxide is selected from the group consisting of Al₂O₃, REO, TiO₂, Y₂O₃, ZrO₂, and complex metal oxides thereof.

16. An article comprising the glass-ceramic of claim 11, wherein the article is selected from the group consisting of protective covers, cell phone display covers, portable electronic device display covers, watch covers, lighting elements, lenses, IR windows, tubes, rods, windows, prisms, and wave guides.

17. A method of making a glass-ceramic article comprising:
providing a plurality of glass bodies comprising a first metal oxide and a second metal oxide, wherein the first metal oxide and the second metal oxide are different from one another, the glass bodies having a T_{g} and Tₓ, wherein the difference between T_{g} and Tₓ is at least 5 degrees Celsius, and wherein the glass bodies contain not more than 20 percent by weight SiO₂, not more than 20 percent by weight B₂O₃, and not more than 40 percent by weight P₂O₅, based on the total weight of the glass bodies;
heating the glass bodies above the T_{g} and coalescing at least a portion of the plurality of glass bodies to provide a bulk glass body;
selecting a target heat-treatment protocol to substantially optimize the in-line transmission and hardness of the glass-ceramic; and
heat-treating the bulk glass body using the target heat-treatment protocol to form the glass-ceramic.

18. The method of claim 17 further comprising selecting a minimum in-line transmission, and wherein the target heat-treatment protocol is selected to optimize hardness by heat-treating the glass body without going below the minimum in-line transmission.

19. The method of claim 17 wherein the first metal oxide and second metal oxide are selected from the group consisting of Al₂O₃, Bi₂O₃, CaO, CoO, Cr₂O₃, CuO, Fe₂O₃, Ga₂O₃, HfO₂, MgO, MnO, Nb₂O₅, NiO, REO, Sc₂O₃, Ta₂O₅, TiO₂, V₂O₅, Y₂O₃, ZnO, ZrO₂, and complex metal oxides thereof.

20. The method of claim 17 wherein the glass-ceramic comprises not more than 20 percent by weight collectively B₂O₃, GeO₂, P₂O₅, SiO₂, TeO₂, and combinations thereof, based on the total weight of the glass-ceramic

21. A method of making a glass-ceramic article comprising:
providing a plurality of glass bodies comprising a first metal oxide and a second metal oxide, wherein the first metal oxide and the second metal oxide are different from one another, the glass bodies having a T_{g} and Tₓ, wherein the difference between T_{g} and Tₓ is at least 5 degrees Celsius, and wherein the glass bodies contain not more than 20 percent by weight SiO₂, not more than 20 percent by weight B₂O₃, and not more than 40 percent by weight P₂O₅, based on the total weight of the glass bodies;
heating the glass bodies above the T_{g} and coalescing at least a portion of the plurality of glass bodies to provide a bulk glass body; and
heat-treating the bulk glass body using a target heat-treatment protocol selected to obtain an in-line transmission that is within 30 percent of the in-line transmission at the Transmission Loss Point.

22. The method of claim 21 wherein the target heat-treatment protocol is selected to optimize the in-line transmission by heat-treating the glass body at a temperature within 50 degrees Celsius of the temperature at the Transmission Loss Point.

23. The method of claim 21 wherein the first metal oxide and second metal oxide are selected from the group consisting of Al₂O₃, Bi₂O₃, CaO, CoO, Cr₂O₃, CuO, Fe₂O₃, Ga₂O₃, HfO₂, MgO, MnO, Nb₂O₅, NiO, REO, Sc₂O₃, Ta₂O₅, TiO₂, V₂O₅, Y₂O₃, ZnO, ZrO₂, and complex metal oxides thereof.

24. The method of claim 21 wherein the glass-ceramic comprises not more than 20 percent by weight collectively B₂O₃, GeO₂, P₂O₅, SiO₂, TeO₂, and combinations thereof, based on the total weight of the glass-ceramic.

25. A method of making a glass-ceramic article comprising:
providing a glass body comprising a first metal oxide selected from the group consisting of Al₂O₃, CaO, CoO, Cr₂O₃, CuO, Fe₂O₃, HfO₂, MgO, MnO, Nb₂O₅, NiO, REO, Sc₂O₃, Ta₂O₅, TiO₂, V₂O₅, Y₂O₃, ZnO, ZrO₂, and complex metal oxides thereof, and a second metal oxide selected from the group consisting of Al₂O₃, Bi₂O₃, CaO, CoO, Cr₂O₃, CuO, Fe₂O₃, Ga₂O₃, HfO₂, MgO, MnO, Nb₂O₅, NiO, REO, Sc₂O₃, Ta₂O₅, TiO₂, V₂O₅, Y₂O₃, ZnO, ZrO₂, and complex metal oxides thereof, wherein the first metal oxide and the second metal oxide are different from one another, and wherein the glass body contains less than 20% by weight SiO₂, less than 20% by weight B₂O₃, and less than 40% by weight P₂O₅, based on the total weight of the glass body;
heat-treating the glass body to form a glass-ceramic using a heat-treatment protocol selected to substantially optimize the in-line transmission and hardness of the glass-ceramic.

26. The method of claim 25 wherein the glass-ceramic comprises not more than 20 percent by weight collectively B₂O₃, GeO₂, P₂O₅, SiO₂, TeO₂, and combinations thereof, based on the total weight of the glass-ceramic.
